(19) United States
(12) Patent Application Publication
(10) Pub. No.: US 2017/0039811 A1
(43) Pub. Date: Feb. 9, 2017

(54) METHOD AND SYSTEM FOR DYNAMIC DETERMINING OF ODDS FOR LIVE EVENTS BETTING

(71) Applicant: iPro, Inc., Incline Village, NV (US)

(72) Inventors: Shanmugapriyan DEVARAJ, Portland, OR (US); David ORTIZ, Newcastle, WA (US); Michael SHEIRBON, Seattle, WA (US)

(21) Appl. No.: 14/821,469

(22) Filed: Aug. 7, 2015

(51) Int. Cl. G07F 17/32

(52) U.S. Cl. CPC G07F 17/3288; G07F 17/323

(57) ABSTRACT

Methods and systems for dynamic determining of odds for live events betting. In accordance with an embodiment of the present invention, a computer system determines odds of a micro event within a live event. The determination is based on at least one dynamic factor that is updated during the live event. In addition, the odds of the micro event are presented to a user of a live events wagering application. The odds may be determined on the same computer system that presents the odds to the user, in some embodiments. The odds may be determined on a second computer system, and the odds transmitted wirelessly to a first computer system that presents the odds to the user, in some embodiments.

### RELATED APPLICATIONS

This application is related to co-pending, commonly owned U.S. patent application Ser. No. 14/684,077, attorney docket IPRO-0001-01.01US, filed Apr. 10, 2015, entitled “Method and System for Seamless Transitions between Game Types for Portable Computer Systems” to Devaraj et al., and is hereby incorporated by reference herein in its entirety.

This application is related to co-pending, commonly owned U.S. patent application Ser. No. 14/684,099, attorney docket IPRO-0002-01.01US, filed Apr. 10, 2015, entitled “System and Method for Accepting and Creating Electronic Wagers” to Ortiz et al., and is hereby incorporated by reference herein in its entirety.

This application is related to co-pending, commonly owned U.S. patent application Ser. No. 14/684,134, attorney docket IPRO-0003-01.01US, filed Apr. 10, 2015, entitled “System and Method for On-line Wagering on Real Time Events” to Ortiz et al., and is hereby incorporated by reference herein in its entirety.

This application is related to co-pending, commonly owned U.S. patent application Ser. No. 14/684,161, attorney docket IPRO-0004-01.01US, filed Apr. 10, 2015, entitled “System and Method for On-line Fantasy Wagering” to Ortiz et al., and is hereby incorporated by reference herein in its entirety.

This application is related to co-pending, commonly owned U.S. patent application Ser. No. 14/684,184, attorney docket IPRO-0005-01.01US, filed Apr. 10, 2015, entitled “System and Method for On-Line Multi-Player Interactive Wagering” to Devaraj et al., and is hereby incorporated by reference herein in its entirety.

This application is related to co-pending, commonly owned U.S. patent application Ser. No. 14/684,210, attorney docket IPRO-0006-01.01US, filed Apr. 10, 2015, entitled “Graphical User Interface for On-Line Gaming” to Ortiz et al., and is hereby incorporated by reference herein in its entirety.

U.S. Pat. No. 8,790,176, entitled “System and Method for Real Time Interactive Entertainment” to Hopf and Ortiz, is hereby incorporated by reference in its entirety.

### FIELD OF INVENTION

Embodiments of the present invention relate to the field of electronic applications for mobile computer systems. More specifically, embodiments of the present invention relate to systems and methods for dynamic determining of odds for live events betting.

### BACKGROUND

On-line wagering on live events is a growing form of interactive amusement. Under the convention art, some on-line live events wagering systems present a user, or player, with computed odds, e.g., that a particular team will win a sporting contest. Unfortunately, under the conventional art, such computed odds are based on historical, and often out of date, statistics. Accordingly, such computed odds are less accurate than desired. In addition, under the convention art, such computed odds are generally only available for “high level” wagers, for example, wagers on the outcome of an entire sporting event. It is often desirable to wager on “micro” events, for example, individual plays or characteristics of individual plays, within an overall live event.

### SUMMARY OF THE INVENTION

Therefore, what is needed are methods and systems for dynamic determining of odds for live events betting. What is additionally needed are methods and systems for dynamic determining of odds for live events betting that enable betting on micro events. A need also exists for methods and systems for dynamic determining of odds for live event betting, e.g., including “social,” “fantasy,” and real money wagering, that determines odds of a micro event based on dynamically updated factors. Further, a need exists for methods and systems for dynamic determining of odds for live event betting that are compatible and complementary with existing systems and methods of on-line and/or mobile gaming. Embodiments of the present invention provide these advantages.

In accordance with an embodiment of the present invention, a computer system determines odds of a micro event within a live event. The determination is based on at least one dynamic factor that is updated during the live event. The at least one dynamic factor may be the most recent micro event of the live event, in some embodiments. The at least one dynamic factor may be the most recent micro event of the live event that is relevant to determining the odds of the micro event, in some embodiments. In addition, the odds of the micro event are presented to a user of a live event wagering application. The live event wagering application may be running on the computer system. The odds may be determined on the same computer system that presents the odds to the user, in some embodiments. The odds may be determined on a second computer system, and the odds transmitted wirelessly to a first computer system that presents the odds to the user, in some embodiments.

In accordance with an embodiment of the present invention, a mobile electronic system includes one or more processors coupled to a bus, a memory coupled to the one or more processors, wherein the memory includes a gaming application, a position determining system coupled to the bus operable to determine a geolocation of the electronic system, and a graphical user interface coupled to the bus. The mobile electronic system is configured to determine odds of a micro event within a live event based on at least one dynamic factor updated during the live event and present the odds to a user of a live event wagering application.

In accordance with an embodiment of the present invention, an article of manufacture includes a computer readable medium having instructions stored thereon that, responsive to execution by an electronic system, cause the electronic system to perform operations including determining odds of a micro event within a live event, wherein the determining is based on at least one dynamic factor updated during the live event and presenting the odds to a user of a live event wagering application.

### BRIEF DESCRIPTION OF THE DRAWINGS

The accompanying drawings, which are incorporated in and form an integral part of this specification, illustrate embodiments of the invention and, together with the description, serve to explain the principles of the invention. Unless otherwise noted, the drawings are not drawn to scale.

FIG. 1 illustrates an exemplary block diagram of an exemplary electronic system, which may be used as a platform to implement embodiments of the present invention.

FIG. 2 is a data flow diagram, in accordance with embodiments of the present invention.

FIG. 3 illustrates an exemplary system of dynamic odds determination, in accordance with embodiments of the present invention.

FIG. 4 illustrates an exemplary method, in accordance with embodiments of the present invention.

FIG. 5 illustrates an exemplary graphical user interface (GUI) for accepting wagers for a live event, in accordance with embodiments of the present invention.

FIG. 6 illustrates an exemplary graphical user interface (GUI) for placing a wager on a live event, in accordance with embodiments of the present invention.

FIG. 7 illustrates an exemplary graphical user interface (GUI) for accepting wagers for a live event, in accordance with embodiments of the present invention.

FIG. 8 illustrates an exemplary graphical user interface (GUI) for placing a wager on a live event, in accordance with embodiments of the present invention.

FIG. 9 illustrates an exemplary graphical user interface (GUI) for placing a wager on a live event, in accordance with embodiments of the present invention.

### DETAILED DESCRIPTION

Reference will now be made in detail to various embodiments of the present invention, examples of which are illustrated in the accompanying drawings. While the invention will be described in conjunction with these embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. However, it will be recognized by one of ordinary skill in the art that the invention may be practiced without these specific details. In other instances, well known methods, procedures, components, and circuits have not been described in detail as not to unnecessarily obscure aspects of the invention.

### NOTATION AND NOMENCLATURE

Some portions of the detailed descriptions which follow (e.g., methods 400) are presented in terms of procedures, steps, logic blocks, processing, and other symbolic representations of operations on data bits that may be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accepting” or “selecting” or “determining” or “displaying” or “computing” or “sending” or “receiving” or “reducing” or “detecting” or “setting” or “accessing” or “placing” or “testing” or “forming” or “mounting” or “removing” or “ceasing” or “stopping” or “coating” or “processing” or “performing” or “generating” or “adjusting” or “creating” or “executing” or “continuing” or “indexing” or “translating” or “calculating” or “measuring” or “gathering” or “running” or the like, refer to the action and processes of, or under the control of, a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The terms “micro event” and “sub-event” are used to refer to or to describe an activity within a larger “event,” the outcome of which may be subject to a wager. For example, a football game may be considered an “event,” while individual plays within the game may be considered “micro events.” Similarly, a baseball game may be considered an “event,” while each pitch, and the resulting outcome, e.g., ball, strike, single, double, triple, home run, sacrifice fly, etc., may be considered a “micro event.” As a further example, an automobile race may be considered an “event,” while individual laps, pitstop durations, and/or crashes may be considered “micro events.”

Other live events may not be considered sporting events. For example, television game shows may be live events. In such events, individual rounds or contestant's performance(s) may be considered micro events of the larger event.

For games or other live events with a less defined play structure, e.g., basketball or soccer, a fixed duration of game time, e.g., five minutes, may constitute a “micro event.”

It is appreciated, however, that such games or events may comprise discernable micro events. For example, in a game of basketball, the result(s) of free throws, three-point shots and/or rebounds may be considered micro events. Such micro events may be used in determining odds even if, for example, an on-line wagering system does not allow a user to bet on those same micro events. For example, dynamic statistics on three-point shooting may be used to determine odds of a team scoring a particular number of points in a five-minute interval. Embodiments in accordance with the present invention are well suited to wagers based on events and micro events within such events.

### Method and System for Dynamic Determining of Odds for Live Events Betting

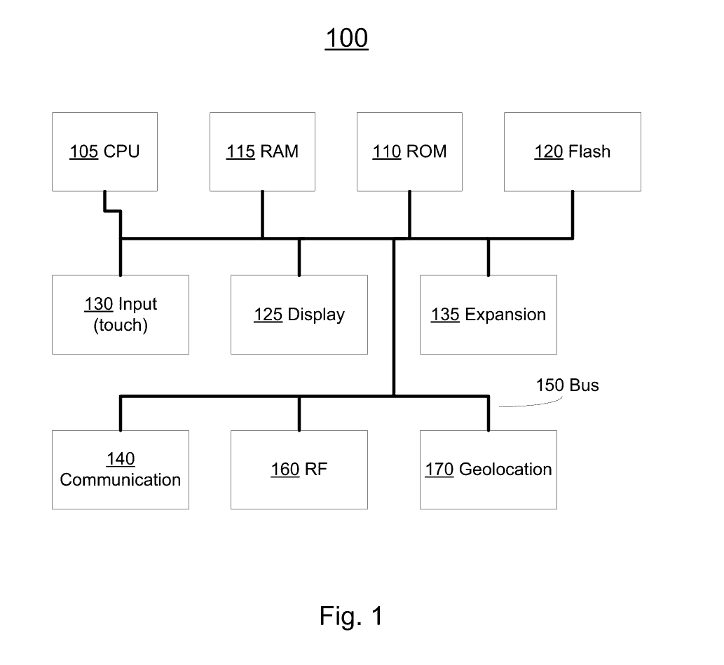

FIG. 1 illustrates an exemplary block diagram of an exemplary electronic system 100, which may be used as a platform to implement embodiments of the present invention. Electronic system 100 may be battery-powered, in some embodiments. Electronic system 100 may be a “server” computer system, in some embodiments. Electronic system 100 may comprise a desktop or generally “fixed location” computer system, in some embodiments. Electronic system 100 may comprise a portable computer system, e.g., a “smart” phone. Electronic system 100 may comprise a “wearable” computer system, e.g., a “smart” watch or an “eye-glasses-mounted” computer system. Electronic system 100 includes an address/data bus 150 for communicating information, a central processor 105 functionally coupled with the bus for processing information and instructions. Central processor 105 may comprise a single processor or multiple processors, e.g., a multi-core processor, or multiple separate processors, in some embodiments. Electronic system 100 also includes a volatile memory 115 (e.g., random access memory RAM) coupled with the bus 150 for storing information and instructions for the central processor 105, and a non-volatile memory 110 (e.g., read only memory ROM) coupled with the bus 150 for storing static information and instructions for the processor 105. Electronic system 100 also optionally includes a changeable, non-volatile memory 120 (e.g., flash) for storing information and instructions for the central processor 105 which can be updated after the manufacture of system 100. In some embodiments, only one of ROM 110 or Flash 120 may be present.

Also included in electronic system 100 of FIG. 1 is an optional input device 130. Device 130 can communicate information and command selections to the central processor 100. Input device 130 may be any suitable device for communicating information and/or commands to the electronic system 100. For example, input device 130 may take the form of a keyboard, buttons, a joystick, a track ball, an audio transducer, e.g., a microphone, a touch sensitive digitizer panel, eyeball scanner and/or the like. A touch sensitive digitizer panel may comprise any suitable technology, e.g., capacitive, resistive, optical, acoustic and/or pressure responsive touch panels. Activation of a “touch” sensitive digitizer panel may not require actual touching of the panel 130 or the electronic system 100, in some embodiments. For example, capacitive touch panels may sense proximity of a user's finger or an eyeball scanner may detect a direction of a user's gaze.

The display unit 125 utilized with the electronic system 100 may comprise a liquid crystal display (LCD) device, cathode ray tube (CRT), field emission device (FED, also called flat panel CRT), light emitting diode (LED), plasma display device, electro-luminescent display, electronic paper, electronic ink (e-ink) or other display device suitable for creating graphic images and/or alphanumeric characters recognizable to the user. Display unit 125 may have an associated lighting device, in some embodiments. Display unit 125 may comprise a head-mounted display, in some embodiments.

The touch sensitive digitizer panel 130 is generally associated with the display unit 125. For example, a function of the touch sensitive digitizer panel 130 generally associated with the display unit 125 is to localize a touch input, e.g., from a finger or stylus, to a portion of display unit 125, for example, a single icon image displayed on display unit 125. The touch sensitive digitizer panel may be in front of the actual display device, e.g., in a viewer's optical path, or the touch sensitive digitizer panel may be outside of a viewer's optical path, e.g., behind or to the side of the display device. The touch sensitive digitizer panel 130 may have different planar dimensions in comparison to planar dimensions of a display unit 125. For example, the touch sensitive digitizer panel 130 may be smaller than display unit 125, e.g., the display unit 125 may extend beyond the touch sensitive digitizer panel 130. Similarly, the touch sensitive digitizer panel 130 may be larger than display unit 125, e.g., the touch panel may extend beyond the display unit. The touch sensitive digitizer panel may be integral to a display assembly, or a separate assembly within the electronic system 100. A touch sensitive digitizer panel is not required.

Electronic system 100 also optionally includes an expansion interface 135 coupled with the bus 150. Expansion interface 135 can implement many well known standard expansion interfaces, including without limitation the Secure Digital Card interface, universal serial bus (USB) interface, Compact Flash, Personal Computer (PC) Card interface, CardBus, Peripheral Component Interconnect (PCI) interface, Peripheral Component Interconnect Express (PCI Express), mini-PCI interface, IEEE 1394, Small Computer System Interface (SCSI), Personal Computer Memory Card International Association (PCMCIA) interface, Industry Standard Architecture (ISA) interface, RS-232 interface, and/or the like. In some embodiments of the present invention, expansion interface 135 may comprise signals substantially compliant with the signals of bus 150.

A wide variety of well known devices may be attached to electronic system 100 via the bus 150 and/or expansion interface 135. Examples of such devices include without limitation rotating magnetic memory devices, flash memory devices, digital cameras, wireless communication modules, digital audio players, biometric monitors and/or Global Positioning System (GPS) devices.

System 100 also optionally includes a communication port 140. Communication port 140 may be implemented as part of expansion interface 135. When implemented as a separate interface, communication port 140 may typically be used to exchange information with other devices via communication-oriented data transfer protocols. Examples of communication ports include without limitation RS-232 ports, universal asynchronous receiver transmitters (UARTs), USB ports, infrared light transceivers, ethernet ports, IEEE 1394 and synchronous ports.

System 100 optionally includes a radio frequency module 160, which may implement a mobile telephone, a wireless network, e.g., IEEE 802.11 (“Wi-Fi”), Bluetooth, a pager, or a digital data link. Radio frequency module 160 may be interfaced directly to bus 150, via communication port 140, via expansion interface 135, or any suitable interface. Various features of electronic system 100 may be implemented by a combination of hardware and/or software. Electronic system 100 may comprise additional software and/or hardware features (not shown) in some embodiments.

Various modules of system 100 may access computer readable media, and the term is known or understood to include removable media, for example, Secure Digital (“SD”) cards, CD and/or DVD ROMs, diskettes and the like, as well as non-removable or internal media, for example, hard drives, RAM, ROM, flash, and the like.

Electronic system 100 may comprise one or more geolocation determining features 170. For example, electronic system 100 may determine its position by use of a Global Positioning System (GPS), including, for example, the United States Global Position System, the planned European Union Galileo positioning system, India's Indian Regional Navigational Satellite System and/or the Chinese Compass navigation system. Electronic system 100 may also determine its position via a mobile telephone network, for example, identifying, measuring signal strength, and/or triangulation of cell towers. Electronic system 100 may also determine its position from known locations of wireless networks, e.g., WiFi hotspots, from an internet protocol (IP) address, or any other applicable location service(s). Geolocation determining features 170 may comprise dedicated hardware, or may utilize components with one or more other uses.

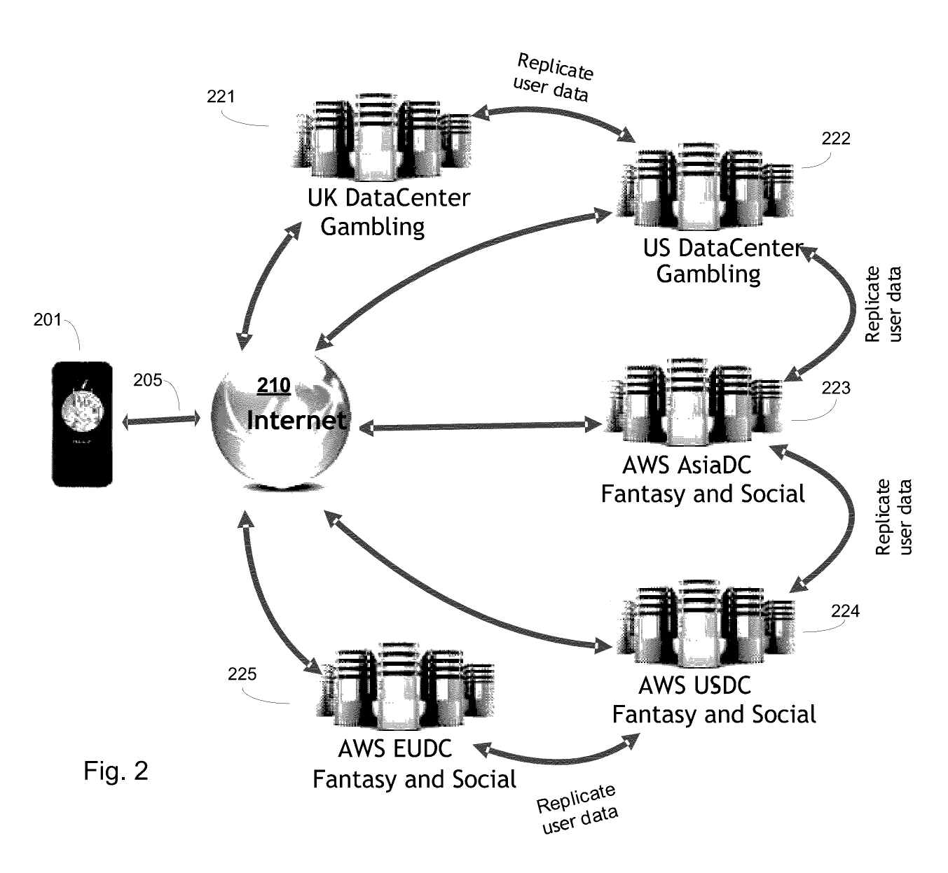

FIG. 2 illustrates data flow, in accordance with embodiments of the present invention. Computer system 201, which may be a portable or non-portable embodiment of exemplary electronic system 100 as illustrated in FIG. 1, communicates 205 with the internet 210. The communication may take any suitable form, for example, via mobile data or a wireless local area network (LAN). In accordance with embodiments of the present invention, one such communication may comprise information of a sporting event of interest to a user of computer system 201. The information is forwarded to one of a plurality of regional data centers 221, 222, 223, 224, 225. The information may be forwarded to a closest data center, or the information may be forwarded to an arbitrary data center, in accordance with embodiments of the present invention.

The regional data centers 221, 222, 223, 224, 225 each cover a defined territory, which may overlap. Each regional data center is configured to provide odds related information on a variety of sporting events. The sporting events may be restricted to sporting events within a data center's defined territory, in some embodiments. In accordance with embodiments of the present invention, a data center may provide odds related information on sporting events outside of a data center's defined territory.

Once the information is received at a regional data center, e.g., “UK Data Center” 221, the regional data center determines if the received information corresponds to a sporting event served by the regional data center. If the received information corresponds to a location within the service area of the regional data center, that regional data center determines an allowable type of game play, e.g., real-money, social chips and/or fantasy, and sends a message back to the portable computer system 201 indicating what type(s) of game(s) are legal at the portable computer system 201's present location.

If the received information does not correspond to a sporting event served by the regional data center, that regional data center forwards the information to the regional data center responsible for the sporting event. In accordance with embodiments of the present location, such forwarding need not be exact or accomplished in a single “hop.” Rather, a regional data center receiving information not handled by the regional data center forwards the information to another regional data center believed to be “closer” or more accurate in responding to the information. In this novel manner, a given regional data center does not need to know details of all events covered by other data centers

Once information of the current sporting event is received at the correct data center, that data center sends a message back to computer system 201. The message may comprise dynamically computed odds for the sporting event, dynamically computed odds for a micro event within the sporting event, or the message may comprise information that enables the computer system 201 to dynamically determine the odds of the sporting event, or of a micro event within the sporting event.

In accordance with embodiments of the present invention, odds of a live event, or a micro-event of a live event, may be determined based on a variety of factors. Some of these factors are considered historical. For example, such historical factors represent past performance of a team over a period of time, e.g., for the current season. Historical player statistics may be seasonal and/or career, for example. Other factors are considered to be dynamic, e.g., such factors are dynamically changing during the course of a game. For example, a quarterback's completion percentage for a season is considered historical. The quarterback's current streak of seven consecutive completions within the present game is considered dynamic. In addition, the characteristics of a current micro event may be considered. For example, given a current game situation, how likely is any pass-attempt micro event? Such characteristics may be considered independently of a conditional probability of results if a pass is attempted, in accordance with embodiments of the present invention.

In accordance with embodiments of the present invention, both historical factors and dynamic factors are considered in determining odds of a live event, or a micro-event of a live event. Factors considered, without limitation, may include: historical statistics based factors for every criteria offered in the game, individual player performance in the game (game-level dynamic statistics), team performance in the game (game-level dynamic statistics), previous micro-event outcomes in the game (game-level dynamic statistics), possible micro-event outcomes, time remaining in a game, scored differential, and, for football, field position. It is to be appreciated that all but the historical statistics based factors change dynamically within a game, e.g., as a result of each micro event.

The system tracks, for example, various sports specific data for teams and players' events at the game and micro event level, and uses that data for calculating odds. Every micro event may not change the odds but every event warrants odds calculation. The odds may be provided for each betting position in the game along with the overall game outcome. For example if the user is making bet that the next play of a particular National Football League (NFL) game will be a rush, every micro event will trigger a calculation for any betting position associated with a rush event. As there are numerous micro events happening in the game, every event may not trigger all the various bet type odds calculation. The system determines which event is associated with which bet type and calculate those position bet odds. The system is also capable of triggering removal of bet types if the criteria are met or the outcome for that bet type is achieved. For example, consider a wager that the Seattle quarterback will throw for 150 yards. When that specific criterion is met in the game, e.g., after the Seattle quarterback has already thrown for 150 yards, then that betting option will be automatically removed from the betting slip. The odds of individual bet positions will move in both direction based on the current state of the game and play.

The odds system tracks every player and team's statistical data for the game and when the game is over the game level tracking may be removed from the in-memory processing unit.

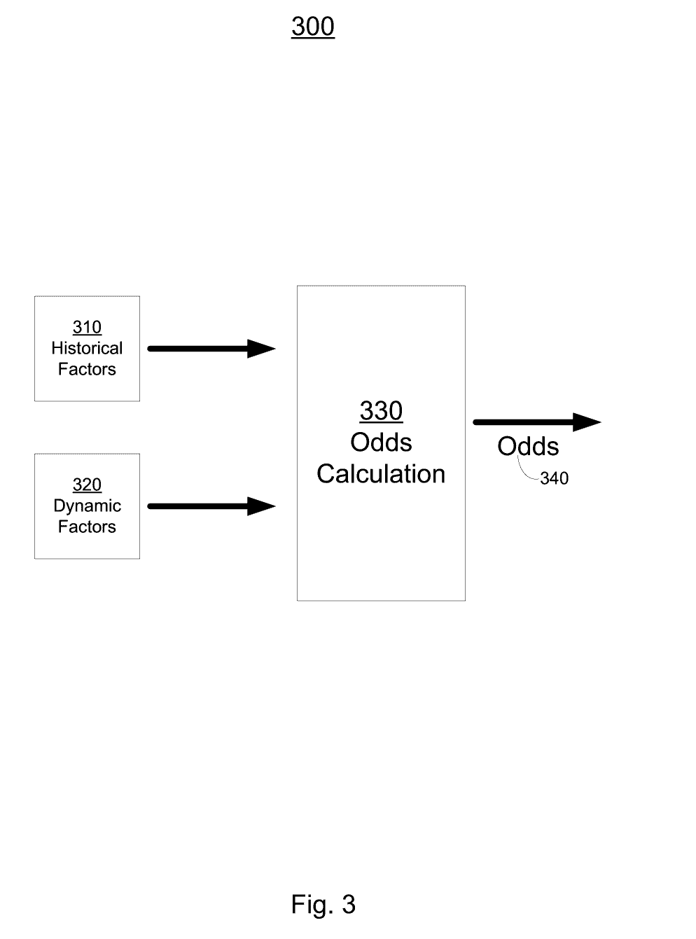

FIG. 3 illustrates an exemplary system 300 of dynamic odds determination, in accordance with embodiments of the present invention. In system 300, historical factors 310 and dynamic factors 320 are accessed by an odds calculation engine 330 to produce odds 340. For example, historical factors 310 may comprise historical and/or season statistics.

For each player and team the system tracks various data points to calculate the odds. For example, a quarterback performs multiple activities in the NFL game, so the system should track them. For example, Pass, Run, Interception, and Touchdown are some of the quarterback events, and the system tracks multiple data points for these events per player.

Dynamic factors 320 may comprise the following dynamic factors for events of NFL games:

Team offense identity—is the team characterized as being run oriented, e.g., greater than 55% runs, pass oriented e.g., greater than 55% passing plays, or balanced, e.g., less than 55% of either passes or runs? This factor may be maintained for season year to date and/or current game.

Offense with top ten ranking—is the teams' offense, e.g., in terms of points scored, currently ranked within the top ten in the league?

Defense with top ten ranking—is the teams' defense, e.g., in terms of points allowed, currently ranked within the top ten in the league?

Current score differential (+/−14 points)—is the team leading or trailing by 14 points or more?

Quarter—Which quarter is the game currently in?

Two-minute warning—is the game within the last two minutes of a half?

Field position—is the offense in the “red zone,” e.g., within 20 yards of the goal? Is the offense backed up, e.g., within ten yards of their own end zone?

Other dynamic factors may include, for example, down and distance, defensive scores, passing yards, pass completions, passing touchdowns, quarterback interceptions, receptions, receiving yards, receiving touchdowns, rush attempts, rushing yards, rushing touchdowns, field goals, tackles, fumbles, defensive interceptions, sacks, defensive touchdowns, and/or each player on the roster.

For example, in an exemplary professional football game, there are picks that may be made for every player on the field, e.g., pass, interception, touchdown and run for the quarterback(s); run, catch, touchdown and fumble for wide receivers, tight ends, and running backs; tackle, touchdown, turnover and sack for defensive lineman, linebackers, safety and cornerbacks. Each of the factors referenced above may affect the odds calculated for each of the picks available for each player on the roster. Each sport or live event has a list of factors that will affect the odds calculation for the picks that can be made for every player on the roster or participant in the live event.

Dynamic factors 320 may comprise the following dynamic factors for events of National Basketball Association (NBA) games (per player): points, rebounds, assists, blocks, free throws, three pointers, dunks, steals, fouls, point differential, e.g., team points scored versus team points allowed while player on court, (+/−10 and +/−20), period 1 team points (less than 15 or over 35), period 2 team points (less than 40 or over 65), period 3 team points (less than 60 or over 90), period (1, 2, 3, 4), player has 5 fouls, team in bonus, each player on the roster.

Odds calculation engine 330 may be any suitable odds calculation engine, in accordance with embodiments of the present invention. For example, odds calculation engine 330 may access historical factors 310 and dynamic factors 320, apply a weighting factor to each statistical factor, and add the weighted factors to determine the odds 340.

In accordance with embodiments of the present invention, odds calculation engine 330 may implement “bounds” or limits on odds 340. For example, if odds calculation engine 330 calculates odds of a particular micro event, the reported odds 340 may be subject to a limit, e.g., a maximum value. The limit may be an overall limit, may be applied to a specific player and/or may be applied to a specific instance of micro event.

For example, a user may select to wager that a next micro event is a run by the quarterback, e.g., Joe Namath. Based on historical factors 310 and dynamic factors 320, odds calculation engine 330 may determine that the probability of such a run is very low, e.g., approaching zero. Without wager limits, odds calculation engine 330 may offer very high odds for such a wager, e.g., 100 to 1. With wager limits, odds calculation engine 330 may offer less high odds, e.g., 20 to 1, bounded by an odds limit.

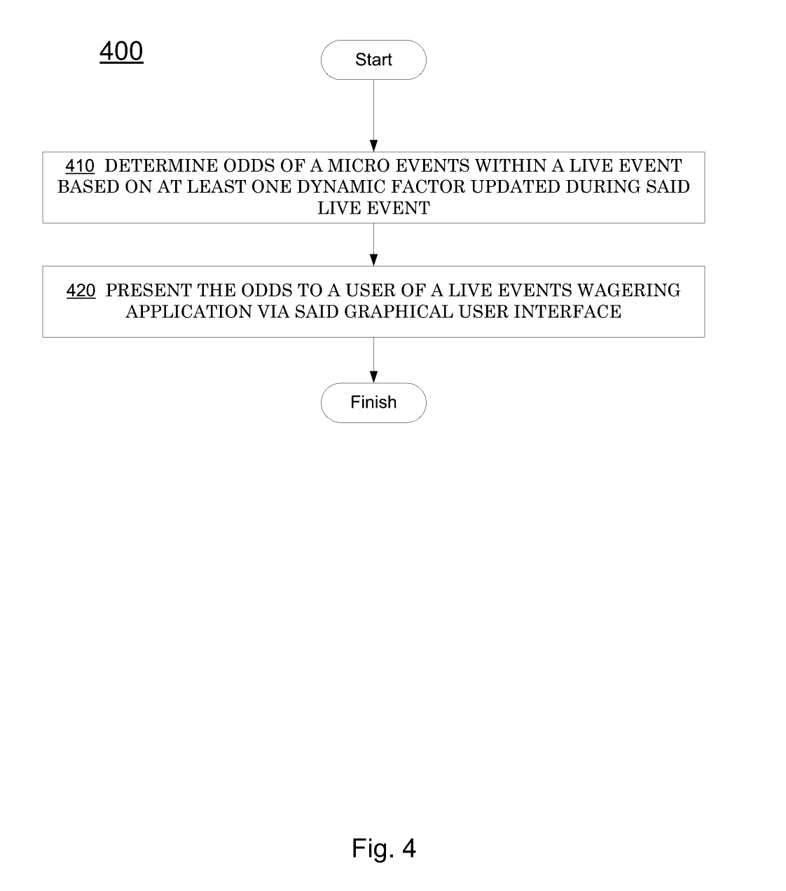

FIG. 4 illustrates an exemplary method 400, in accordance with embodiments of the present invention. In 410, a computer system determines odds of a micro event within a live event. The determination is based on at least one dynamic factor that is updated during the live event. The at least one dynamic factor may be the most recent micro event of the live event, in some embodiments. The at least one dynamic factor may be the most recent micro event of the live event that is relevant to determining the odds of the micro event, in some embodiments.

In 420, the odds of the micro event are presented to a user of a live event wagering application. The live event wagering application may be running on the computer system. The odds may be determined on the same computer system that presents the odds to the user, in some embodiments. The odds may be determined on a second computer system, and the odds transmitted wirelessly to a first computer system that presents the odds to the user, in some embodiments.

In accordance with embodiments of the present invention, the at least one dynamic factor may include any of the dynamic factors previously presented, in any combination.

While the preceding exemplary embodiments have generally be related to sporting events, it is to be appreciated that embodiments in accordance with the present invention are generally well suited to any presentation of an event, or series of events, in which the outcome is unknown to the viewer, or micro events of the event are unknown to the viewer.

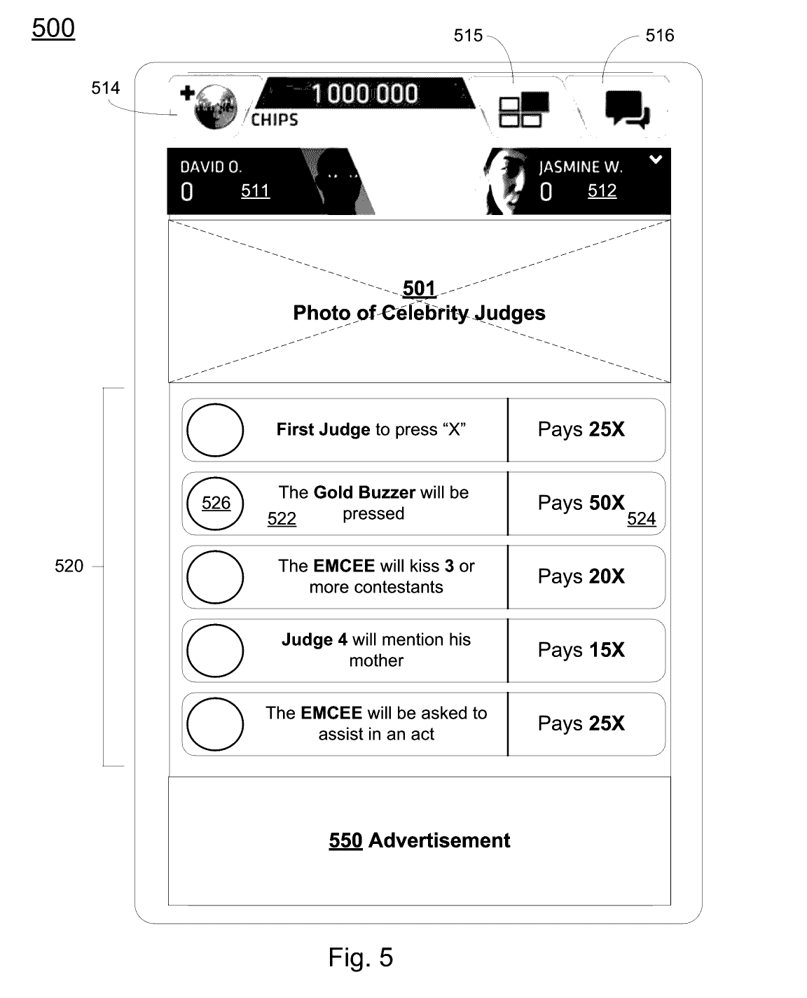

FIG. 5 illustrates an exemplary graphical user interface (GUI) 500 for accepting wagers for a live event, in accordance with embodiments of the present invention. In the example of FIG. 5, the live event comprises a televised talent contest. Graphical user interface 500 comprises a photograph 501 of celebrity judges of the talent contest. Photograph 501 may serve to visually confirm to a user details of the subject event.

Graphical user interface 500 comprises a display 511 of a current player's holdings, e.g., in real currency or a virtual currency, e.g., fantasy or social points or chips. Current player display 511 may include a picture and/or avatar of the current player, in some embodiments. Graphical user interface 500 also comprises a display 512 of an opponent's holdings. Display 512 may display an opponent, from a group of opponents, with a highest score, in some embodiments. Touching display 512 may present a list (not shown) of all opponents. Touching a particular opponent in such a list may cause that particular opponent to be displayed in display 512, in some embodiments. Opponent display 512 may include a picture and/or avatar of the opposing player(s), in some embodiments.

In addition, graphical user interface 500 comprises an add chips icon 514 to add currency, e.g., real currency or a virtual currency, e.g., fantasy or social points or chips, to a player's holdings. Add chips icon 514 may operate as a “rebuy” function, in some embodiments. In accordance with embodiments of the present invention, a user may not be able to add chips in all situations. For example, in a game with an entry fee, e.g., a fantasy game, users are generally not able to, or required to, submit a second entry fee, which may be the equivalent of adding chips in that circumstance. In addition, some games may limit a number of rebuys in a single wagering game. Further, user credit and/or user account balance considerations may prevent a user from adding chips. In such situations, add chips icon 514 may not be presented, in accordance with embodiments of the present invention.

Further, graphical user interface 500 comprises a home icon 515 to take a player to a home screen. Home icon 515 may also display a symbolic indication of location within a multi-level graphical user interface, in some embodiments. Graphical user interface 500 additionally comprises a chat icon 516. Touching or otherwise indicating text icon 516 may enable a user to converse, e.g., via text messaging, voice and/or video conferencing, with an opponent, e.g., an opponent indicated by opponent display 512.

Graphical user interface 500 comprises an optional advertisement display 550. Advertisement display 550 may take any known form, e.g., text, graphics, photo graphics, and/or video graphics. Advertisement display 550 may also be interactive, in some embodiments. For example, a user may touch within, or within a specific portion of advertisement display 550 to initiate interaction with advertisement display 550. For example, responsive to such imitation, a user may be able to obtain more information about a product, or may be presented with an advanced consumer interaction, e.g., a customer survey. In accordance with embodiments of the present invention, interaction with an advanced consumer interaction may present a user with an opportunity to receive additional chip or points for use in the on-line wagering application.

Graphical user interface 500 comprises a list of wager opportunities 520. List of wager opportunities 520 comprises a list of wagers provided by the on-line service provider, e.g., an on-line casino, and/or gaming host. Each water opportunity comprises a statement of the wager, e.g., statement 522, a wager that the “gold buzzer” (a feature of the televised talent show) will be pressed. Each wager opportunity also comprises the odds or payout factor of the wager, e.g., payout factor 524.

Each wager opportunity further comprises a wager selection icon, e.g., wager selection icon 526. Wager selection icon 526 make take the form of a hollow circle. In general, throughout the graphical user interface, a hollow circle represents a wagering opportunity. Touching, or otherwise selecting a wager selection icon, e.g., wager selection icon 526, initiates the subject icon. Generally, wherever a hollow circle appears, touching the hollow circle initiates a wager.

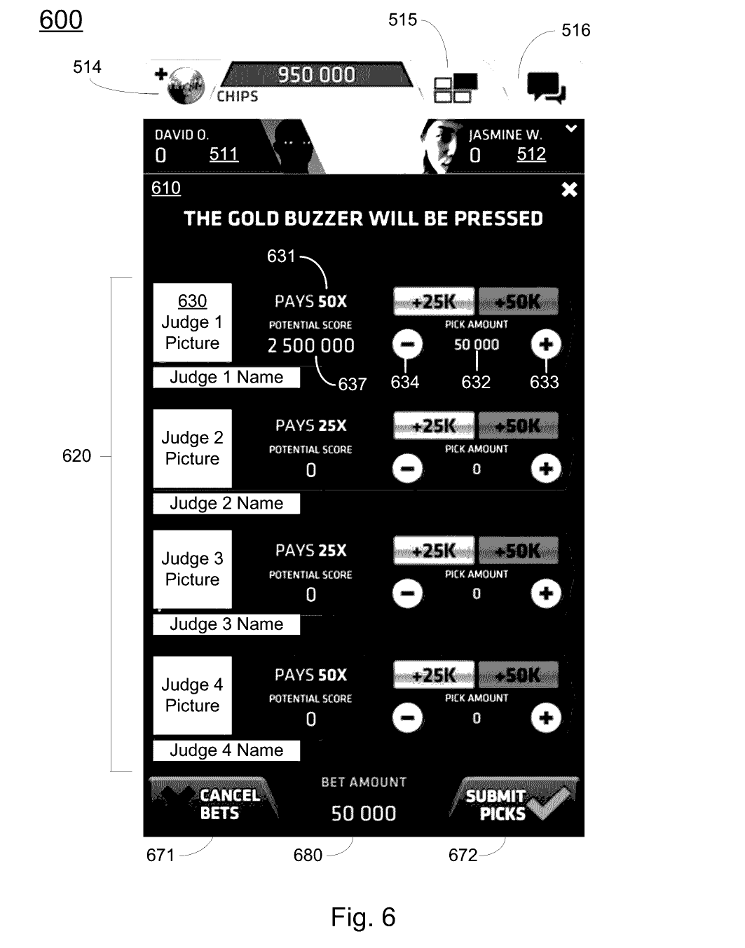

FIG. 6 illustrates an exemplary graphical user interface (GUI) 600 for placing a wager on a live event, in accordance with embodiments of the present invention. Graphical user interface 600 comprises a restatement of the wager 610, for example, as selected in graphical user interface 500 of FIG. 5, for example by touching wager selection icon 526.

Graphical user interface 600 comprises expanded details of the wager. Since the particular wager selected, e.g., “the gold buzzer will be pressed,” implies action by one or more specific judges, graphical user interface 600 comprises a list of the judge-based wagers 620. It is to be appreciated that other types of wager may require and display other types of expanded details, in accordance with embodiments of the present invention.

Each of the list of judge-based wagers 620 comprises a photograph of the judge, e.g., judge 1 photograph 630 and the judge's name. Each of the list of judge-based wagers 620 also comprises a statement of the payout factor and/or odds of the wager, e.g., payout factor 631. It is appreciated that the payout factors for all judges may be different, as each individual judge may have a different likelihood of pressing the “gold buzzer.”

Each of the list of judge-based wagers 620 further comprises a pick amount field 632. Pick amount field 632 displays an amount of a bet and allows a user to change an amount of the bet. For example, a pick amount may be increased by touching plus button 333, and decreased by touching minus button 634. Each of the list of judge-based wagers 620 comprises a potential score display 637. Potential score display 637 displays a potential payout if the wager is won, e.g., judge 1 presses the “gold buzzer,” based on the pick amount 637 and the payout factor 931.

Graphical user interface 600 also comprises a “cancel bets” icon 671, a “submit picks” icon 672 and a “bet amount” display field 680. Bet amount field 680 displays the total amount, e.g., in chips or points, a user will bet, e.g., be at risk, if the wager is placed. Touching or otherwise indicating cancel bets icon 671 terminates the current creation of a bet. Touching or otherwise indicating submit picks icon 672 causes the bet to be created. Generally, a bet must be submitted prior to the snap. A subsequent confirmation screen, e.g., “are you sure?”, may be presented, in accordance with embodiments of the present invention.

Although a wager on only one judge is illustrated in FIG. 6, it is appreciated that wagers may be placed on more than one judge, in accordance with embodiments of the present invention.

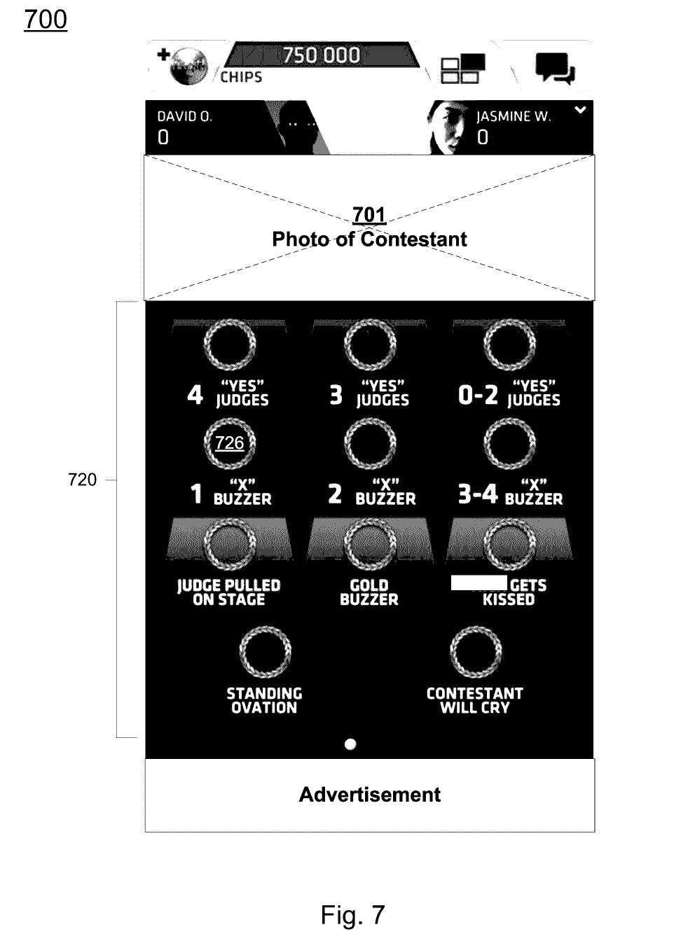

FIG. 7 illustrates an exemplary graphical user interface (GUI) 700 for accepting wagers for a live event, in accordance with embodiments of the present invention. In the example of FIG. 7, the live event comprises a televised talent contest. Graphical user interface 700 comprises a photograph 701 of a current or next contestant in the talent contest. Photograph 701 may serve to visually confirm to a user details of the subject event.

Field 720 of graphical user interface 700 presents a graphical list of possible outcomes of a contestant's performance. It is appreciated that graphical user interface 700 need not present all possible outcomes. Field 720 may comprise multiple display pages, which may be scrolled horizontally and/or vertically, for example. Wager selection icon 726, of field 720, indicates a wager than one judge will hit the “X” buzzer.

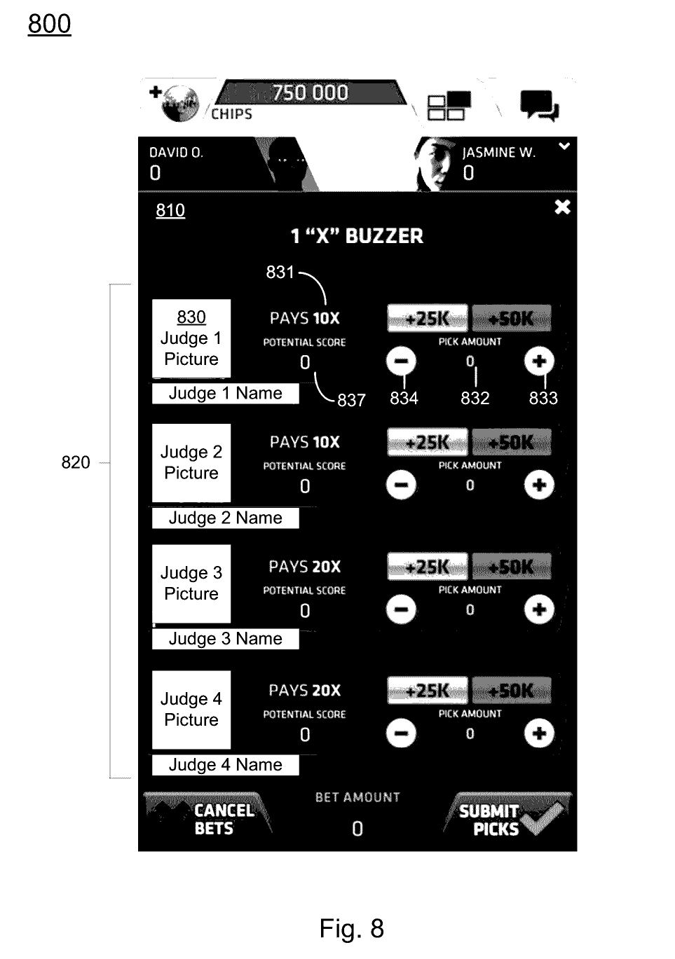

FIG. 8 illustrates an exemplary graphical user interface (GUI) 800 for placing a wager on a live event, in accordance with embodiments of the present invention. Graphical user interface 800 comprises a restatement of the wager 810, for example, as selected in graphical user interface 700 of FIG. 7, for example by touching wager selection icon 726.

Graphical user interface 800 comprises expanded details of the wager. Since the particular wager selected, e.g., “one judge will press the ‘X’ buzzer,” implies action by one specific judge, graphical user interface 800 comprises a list of the judge-based wagers 820. It is to be appreciated that other types of wager may require and display other types of expanded details, in accordance with embodiments of the present invention.

Each of the list of judge-based wagers 820 comprises a photograph of the judge, e.g., judge 1 photograph 830 and the judge's name. Each of the list of judge-based wagers 820 also comprises a statement of the payout factor and/or odds of the wager, e.g., payout factor 831. It is appreciated that the payout factors for all judges may be different, as each individual judge may have a different likelihood of pressing the “X” buzzer.

Each of the list of judge-based wagers 820 further comprises a pick amount field 832. Pick amount field 832 displays an amount of a bet and allows a user to change an amount of the bet. For example, a pick amount may be increased by touching plus button 333, and decreased by touching minus button 834. Each of the list of judge-based wagers 820 comprises a potential score display 837. Potential score display 837 displays a potential payout if the wager is won, e.g., judge 1 presses the “gold buzzer,” based on the pick amount 837 and the payout factor 831.

In accordance with embodiments of the present invention, a system for determining odds for live events betting may utilize both historical and dynamic factors in determining such odds. Historical factors may include statistics for all shows during the current and past seasons. Dynamic factors may generally include situations and outcomes of the current show. For example, in evaluating the odds of whether the emcee will kiss three or more contestants, the number of kisses that have already occurred during a particular show is dynamic and potentially very important to such odds. For example, if the emcee has not kissed any contestants, and there are only two contestants remaining, the odds are very low that the emcee will kiss three or more. If the emcee has already kissed two contestants, and there are many contestants yet to appear, the odds of a third kiss are significantly higher. A historical factor may be the emcee's preference for kissing members of the opposite sex. Additionally, age of the contestants, e.g., young child or elderly woman, may be a factor considered for determining kissing odds.

As a further example, the behavior of a live audience may be considered a dynamic factor. Wagers based directly on audience behavior are contemplated, e.g., whether a contestant receives a standing ovation. Statistics on a particular audience's standing ovation behavior may be utilized in determining odds for a next standing ovation. In related behavior, an audience's behavior may influence judge's behavior. For example, a first audience may be characterized as “subdued,” while a second audience may be characterized as “wildly enthusiastic.” Audiences may be characterized based on number of people standing during a performance and/or on noise level, for example. One may expect more “positive” behavior from judges, e.g., more “yes” votes, appearing before the second audience in comparison to the first audience. Incorporating such dynamic factors into odds determination increases the accuracy of such predictions, in accordance with embodiments of the present invention.

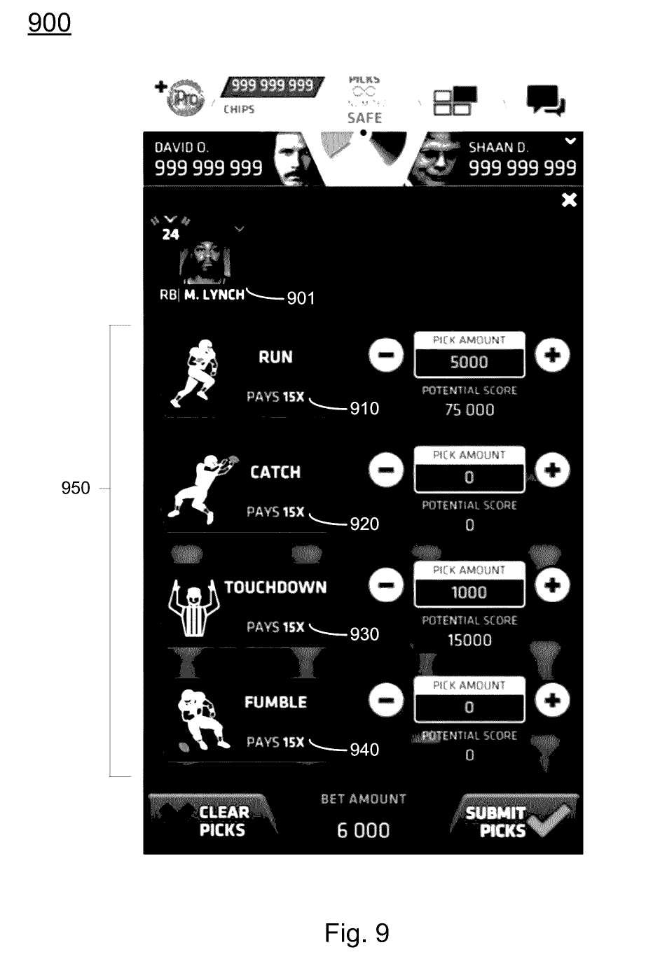

FIG. 9 illustrates an exemplary graphical user interface (GUI) 900 for placing a wager on a live event, in accordance with embodiments of the present invention. Graphical user interface 900 illustrates a plurality of potential wagers and associated odds/payout factors for a future micro event result, e.g., the result of a next play, in a football game. Graphical user interface 900 comprises a player display 901. Player display 901 indicates a player or group of players that is the subject of potential wagers. In the example of graphical user interface 900, a player's name, image, position, and jersey likeness are displayed. In accordance with embodiments of the present invention, only a minimum amount of identifying information need be displayed.

Graphical user interface 900 further comprises a list 950 of a plurality of potential wagers and associated odds/payout factors for a future micro event result, e.g., the result of a next play, in a football game. As illustrated, list 950 indicates possible types of plays and/or results associated with the player identified in player display 901. It is to be appreciated that list 950 is not required to include all possible plays and/or play outcomes, in some embodiments.

Potential wager 910 represents a wager than the player identified in player display 901 will run the ball on the next play. Potential wager 910 also displays the odds and/or payout factor, e.g., odds determined in accordance with embodiments of the present invention, of that particular result. Potential wager 920 represents a wager than the player identified in player display 901 will catch the ball on the next play. Potential wager 920 also displays the odds and/or payout factor, e.g., odds determined in accordance with embodiments of the present invention, of that particular result.

Potential wager 930 represents a wager than the player identified in player display 901 will score a touchdown on the next play. Potential wager 930 also displays the odds and/or payout factor, e.g., odds determined in accordance with embodiments of the present invention, of that particular result. Potential wager 940 represents a wager than the player identified in player display 901 will fumble the ball on the next play. Potential wager 940 also displays the odds and/or payout factor, e.g., odds determined in accordance with embodiments of the present invention, of that particular result.

In accordance with embodiments of the present invention, a user may wager on none, one or more than one of the potential wagers 950. For example, a user may bet on potential wagers 910 and 930, e.g., that the player identified in player display 901 will run the ball for a touchdown on the next play. A user may win one of such multiple wagers, e.g., on a run by the player identified, and lose another one of such multiple wagers, e.g., the run did not result in a touchdown, in accordance with embodiments of the e present invention. Graphical user interface 900 also comprises additional display and/or interface elements with functions and features comparable to those previously described.

While it is not possible to list all historical and dynamic factors to be considered for all live events, the foregoing descriptions, which include sporting events and non-sporting events, enables those of ordinary skill in the art to determine historical and dynamic factors to be considered in determining betting odds for live events, in accordance with embodiments of the present invention.

Embodiments in accordance with the present invention provide methods and systems for dynamic determining of odds for live events betting. In addition, embodiments in accordance with the present invention provide methods and systems for dynamic determining of odds for live events betting that enable betting on micro events. Also, embodiments in accordance with the present invention provide methods and systems for dynamic determining of odds for live events betting that determines odds of a micro event based on dynamically updated factors. Further, embodiments in accordance with the present invention provide methods and systems for dynamic determining of odds for live events betting that determines odds of a micro event based on dynamically updated factors that are compatible and complementary with existing systems and methods of on-line and/or mobile gaming.

Various embodiments of the invention are thus described. While the present invention has been described in particular embodiments, it should be appreciated that the invention should not be construed as limited by such embodiments, but rather construed according to the below claims.

What is claimed is:

1. A computer implemented method comprising:
determining odds of a micro event within a live event, wherein said determining is based on at least one dynamic factor updated during said live event; and
presenting said odds to a user of a live event wagering application.

2. The computer implemented method of claim 1 wherein said at least one dynamic factor is updated based on a most recent micro event.

3. The computer implemented method of claim 2 wherein said most recent micro event is the most recent micro event of the live event.

4. The computer implemented method of claim 2 wherein said most recent micro event is the most recent micro event of the live event that is relevant to determining said odds of said micro event.

5. The computer implemented method of claim 1 wherein said determining takes place on the same computer system that presents said odds to said user.

6. The computer implemented method of claim 1 wherein said determining takes place on a second computer system, and said odds are transmitted wirelessly to a first computer system that presents said odds to said user.

7. The computer implemented method of claim 1 wherein said at least one dynamic factor comprises a team offense identity factor, a current score differential factor and a two-minute warning factor.

8. The computer implemented method of claim 1 wherein said live event is one of a sporting event, a talent contest event, and a television game show event.

9. A mobile electronic system comprising:
one or more processors coupled to a bus;
a memory coupled to said one or more processors, wherein said memory comprises a gaming application;
a position determining system coupled to said bus operable to determine a geolocation of said electronic system;
a graphical user interface coupled to said bus;
wherein said mobile electronic system is configured to:
determine odds of a micro event within a live event based on at least one dynamic factor updated during said live event; and
present said odds to a user of a live event wagering application via said graphical user interface.

10. The mobile electronic system of claim 9 wherein said at least one dynamic factor is updated based on a most recent micro event.

11. The mobile electronic system of claim 10 wherein said most recent micro event is the most recent micro event of the live event.

12. The mobile electronic system of claim 10 wherein said most recent micro event is the most recent micro event of the live event that is relevant to determining said odds of said micro event.

13. The mobile electronic system of claim 9 wherein said odds are determined on said mobile electronic system.

14. The mobile electronic system of claim 9 wherein said odds are determined on a second computer system, and said odds are transmitted wirelessly to said mobile electronic system.

15. The mobile electronic system of claim 9 wherein said at least one dynamic factor comprises an offense top ten ranking factor, a defense top ten ranking factor and a field position factor.

16. The mobile electronic system of claim 9 wherein said live event is one of a sporting event, a talent contest event, and a television game show event.

17. An article of manufacture including a computer readable medium having instructions stored thereon that, responsive to execution by an electronic system, cause said electronic system to perform operations comprising:
determining odds of a micro event within a live event, wherein said determining is based on at least one dynamic factor updated during said live event; and
presenting said odds to a user of a live event wagering application.

18. The article of manufacture of claim 17 wherein said at least one dynamic factor is updated based on a most recent micro event.

19. The article of manufacture of claim 18 wherein said most recent micro event is the most recent micro event of the live event.

20. The article of manufacture of claim 18 wherein said most recent micro event is the most recent micro event of the live event that is relevant to determining said odds of said micro event.

21. The article of manufacture of claim 17 wherein said determining takes place on the same said electronic system that presents said odds to said user.

22. The article of manufacture of claim 17 wherein said determining takes place on a second electronic system, and said odds are transmitted wirelessly to said electronic system.

23. The article of manufacture of claim 17 wherein said live event is one of a sporting event, a talent contest event, and a television game show event.

24. An electronic system comprising:
a determining circuit for determining odds of a micro event within a live event, wherein said determining is based on at least one dynamic factor updated during said live event; and
a presenting module for presenting said odds to a user of a live event wagering application.

25. The electronic system of claim 24 wherein said at least one dynamic factor is updated based on a most recent micro event.

26. The electronic system of claim 25 wherein said most recent micro event is the most recent micro event of the live event.

27. The electronic system of claim 25 wherein said most recent micro event is the most recent micro event of the live event that is relevant to determining said odds of said micro event.

28. The electronic system of claim 24 wherein said determining takes place on the same computer system that presents said odds to said user.

29. The electronic system of claim 24 wherein said determining takes place on a second computer system, and said odds are transmitted wirelessly to a first computer system that presents said odds to said user.

30. The electronic system of claim 24 wherein said at least one dynamic factor comprises a team offense identity factor, a current score differential factor and a two-minute warning factor.

31. The electronic system of claim 24 wherein said live event is one of a sporting event, a talent contest event, and a television game show event.
